(19) United States
(12) Patent Application Publication
(10) Pub. No.: US 2016/0119446 A1
(43) Pub. Date: Apr. 28, 2016

(54) SYSTEM OF NEWS FEED OVER A WEB PLATFORM

(71) Applicant: Adhvith Dhuddu, Bangalore (IN)

(72) Inventor: Adhvith Dhuddu, Bangalore (IN)

(21) Appl. No.: 14/880,295

(22) Filed: Oct. 12, 2015

(30) Foreign Application Priority Data
Oct. 24, 2014 (IN) 5298/CHE/2014

(51) Int. Cl. H04L 29/08; H04L 12/58; H04L 12/24

(52) U.S. Cl. CPC H04L 67/327; H04L 67/02; H04L 41/22; H04L 51/32

(57) ABSTRACT

The present invention is based on a computer program product that is adapted to be executed on a processor that is placed in a client-server environment and on execution it is adapted to enable the processor to perform a given set of steps. A request of a web service is made by a client computing device to a server computing device. This request is sent over the web service and at least a newsfeed by the server computing device to the client computing device. The web service is then displayed onto the client computing device, and further generates a news feed interface within an area of displayed web services. The news feed is then displayed onto the interface which then enables the client computing device to interact with the interface. The computer program product is a web service, which is a social networking web platform.

### FIELD OF INVENTION

The present invention relates to a display of news feed onto a web service running on a client device. More specifically the invention relates to a display of news feed onto a social networking web platform.

### BACKGROUND OF THE INVENTION

In the current scenario when the internet is booming, a business owner is looking for opportunities to reach out and interact with prospects online. Various web services through which the business owner can reach out to a prospect includes emails, company web pages, and networking platforms. The prospect does not move to a web page of the company till the prospect has information about the company. When a company is new or it is not a prominent player in the market, the prospect may not have information about it and they may not be able to reach the company web page of the business user.

To reach out to any prospect, e-mail as a medium has been widely used. However, most of the time, even though the business owner is unaware of whether a prospect has an interest in their product or services, the business owner still sends the email to the presumed prospect. This medium is quite ineffective, as the information doesn't reach the right prospect. Also, in most cases this kind of interaction is considered as spamming, which in turn drastically affects the reputation of the business owner.

In recent times, several networking platforms have surfaced, where many users spend a substantial time of their day. These networking platforms also allow the companies to prospect over its platform. A news feed is a data format used for providing users with frequently updated content over web platform. It is provided on a regular or continuous basis for onward distribution or broadcasting. An exemplary embodiment of a social media platform allows a company to create a profile page of the company on its platform, and allows the company to promote its profile page as a newsfeed on a users update page or timeline.

In an exemplary embodiment on Facebook, which is a social networking web platform, when a user logs in, the default screen upon login is the user's news feed. The Facebook news feed is an aggregation of posts made by the user's friends and the pages the user has liked. Currently, through a Facebook news feed a user can view an image, a video, a link or URL, or plain text. The news feed also has sponsored ads shown by Facebook. Each post on the news feed can be shared, liked or commented upon.

However, through a newsfeed, a business owner only has the option of broadcasting information, but does not have an option to establish a two way communication with the prospect.

### OBJECT OF THE INVENTION

The object of the present invention is to provide news feed onto a web service to establish a two way interaction between the user of the web service and owner of the news feed.

### SUMMARY OF THE INVENTION

The object of the invention is achieved by a computer program product of claim 1, a server computing device of claim 10 and a method of claim 20.

According to one embodiment of a computer program product, the computer program product is adapted to be executed on a processor that is placed in a client-server environment and on execution it is adapted to enable the processor to perform a given set of steps:
requesting of a web service by a client computing device to a server computing device;
sending the web service along with at least a news feed by the server computing device to the client computing device;
displaying of the web service onto a display of the client computing device;
generating a news feed interface within an area of displayed web service;
displaying the news feed onto the interface;
enabling the client computing device to interact with the interface.

According to another embodiment of the computer program product, the processor enables the client computing device to receive an input through the interface and sends the input to the server computing device.

According to yet another embodiment of the computer program product, the interface is adapted to display one or more subsequent display frames to receive the input through the client computing device.

According to one embodiment of the computer program product, the subsequent display frames of the interface are displayed on either receiving the requisite input on a current display frame or by clicking an activation button present on a current display frame.

In a further embodiment of the computer program product, the processor enables the client computing device to interact with the interface for displaying a presentation.

In one embodiment of the computer program product, wherein the presentation is adapted to be interacted and controlled through a user input which is received by the client computing device.

According to an alternate embodiment of the computer program product, the processor enables the client computing device to interact with the interface for playing a game.

According to one embodiment of the computer program product, the processor is enabled to provide an activation module onto the interface to enable the client computing device to interact through the interface.

In yet another preferred embodiment of the computer program product, the web service is a social networking web platform.

### BRIEF DESCRIPTION OF DRAWINGS

FIG. 1 illustrates a flow chart depicting a method of establishing interaction through news feed over a web platform.

FIG. 2 illustrates a client server system establishing interaction through news feed over a web platform.

FIG. 3a-c illustrates an exemplary embodiment of the invention displaying a newsfeed with a presentation.

FIG. 4a-c illustrates another example displaying a news feed for participating in a survey

FIG. 5a-d illustrates another example displaying a newsfeed for playing a game.

FIG. 6a-b illustrates another example displaying a newsfeed with more than one display frame

### DETAILED DESCRIPTION

The best and other modes for carrying out the present invention are presented in terms of the embodiments, herein depicted in Drawings provided. The embodiments are described herein for illustrative purposes and are subject to many variations. It is understood that various omissions and substitutions of equivalents are contemplated as circumstances may suggest or render expedient, but are intended to cover the application or implementation without departing from the spirit or scope of the present invention. Further, it is to be understood that the phraseology and terminology employed herein are for the purpose of the description and should not be regarded as limiting. Any heading utilized within this description is for convenience only and has no legal or limiting effect.

The terms “a” and “an” herein do not denote a limitation of quantity, but rather denote the presence of at least one of the referenced item.

The present invention relates to a display of news feed updates onto a web service running on a client device. This is an altered type of newsfeed update which is based on interactive status updates. These updates are not like the conventional image, video, link or text; it is a more advanced system of updates on the web platform. Through the current invention, a user can interact with a normal status update right on the news feed itself. The preferred embodiments of the invention bring out several actions that can be achieved through the interactive status update.

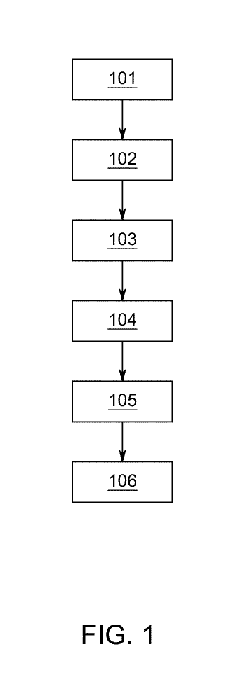

As shown in FIG. 1, the invention is explained through the following steps. Step 101 involves a request of a web service made by a client computing device to a server computing device. In Step 102 the web service and at least a newsfeed is sent by the server computing device to the client computing device. The newsfeed may not be sent along with the web service in one go, rather the newsfeed may be sent subsequently after sending the web service. The next step 103 wherein the web service is then displayed onto the client computing device, and in Step 104 it further generates a newsfeed interface within an area of displayed web services. In Step 105 the newsfeed is then displayed onto the interface followed by Step 106 in which the newsfeed enables the client computing device to interact with the interface.

While explaining the drawings, references are made to the elements which may or may not be present in each and every drawing.

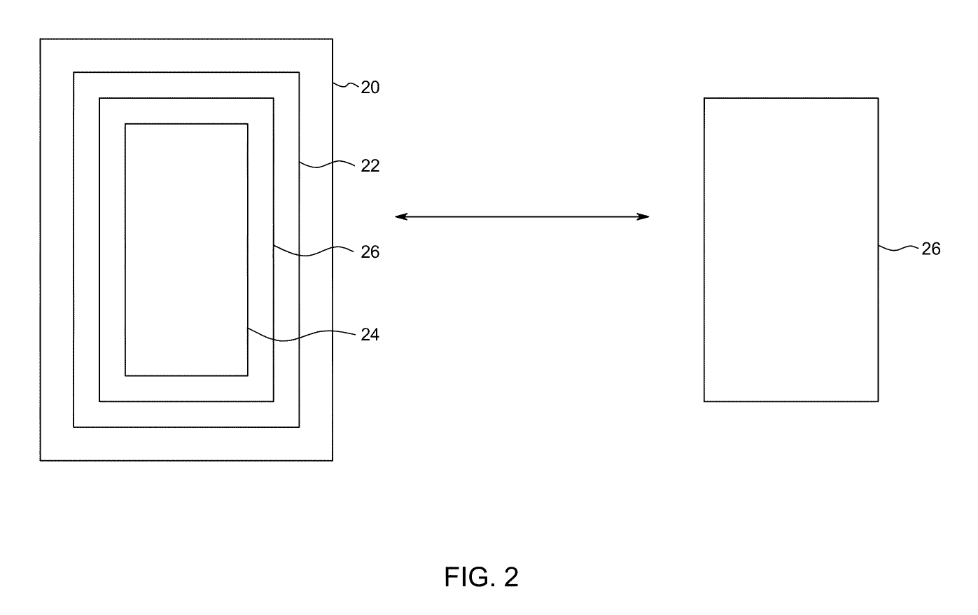

The invention is further explained through a client-server system including a client computing device 20 and a server computing device 26, as shown in FIG. 2. When a computer program product stored in a memory module of the server computing device 26 or client computing device 20, executes onto a processor in physical proximity to client computing device 20 or server computing device 26 or placed in a cloud computing environment, the processor performs the following steps:

requesting of a web service 22 by a client computing device 20 to a server computing device 26;

sending the web service 22 along with at least a news feed 24 by the server computing device 26 to the client computing device 20;

displaying of the web service 22 onto a display 26 of the client computing device 20;

generating a news feed interface 24 within an area of displayed web service 22;

displaying the news feed 24 onto the interface 24;

enabling the client computing device 20 to interact with the interface 24.

The client computing device 20 receives an input through the interface and sends the input to the server computing device 26.

In one embodiment, the interface is adapted to display one or more subsequent display frames 12 to receive the input through the client computing device 20. Alternatively, no subsequent display frames 12 are displayed, wherein after receiving the input onto the initial display frame, the news feed is exited.

In an embodiment, the subsequent display frames 12 of the interface are displayed on either receiving the requisite input on a current display frame 12 or by clicking an activation button 10 present on a current display frame 12.

In a further embodiment of the present invention, the processor enables the client computing device 20 to interact with the interface for displaying a presentation. The presentation is adapted to be interacted and controlled through a user input 14 which is received by the client computing device 20.

According to an alternate embodiment of the computer program product, the processor enables the client computing device 20 to interact with the interface for playing a game. The game can be played by the user by providing an input onto an activation button or a particular type of clicking pattern of mouse or by various key patterns of a keyboard or any other types of input medium including screen touch medium, gesture based medium, etc.

In yet another preferred embodiment, the web service 22 is a social networking web platform.

According to one of the preferred embodiment, the client computing device 20 is enabled to interact through the newsfeed 24 to register for an event/gift/newsletter through the social networking platform. The computing device collects data through the display frames 12 which may include fields such as name, email, phone number, date of event, type of event, number of passes, etc. According to another embodiment, by clicking the activation button 10, as the case may be, a discount for a particular product can be availed, signing up for continuous newsletters can be activated, or availing a special gift can be opted for.

Further, the invention is explained through few exemplary implementations of the client server system.

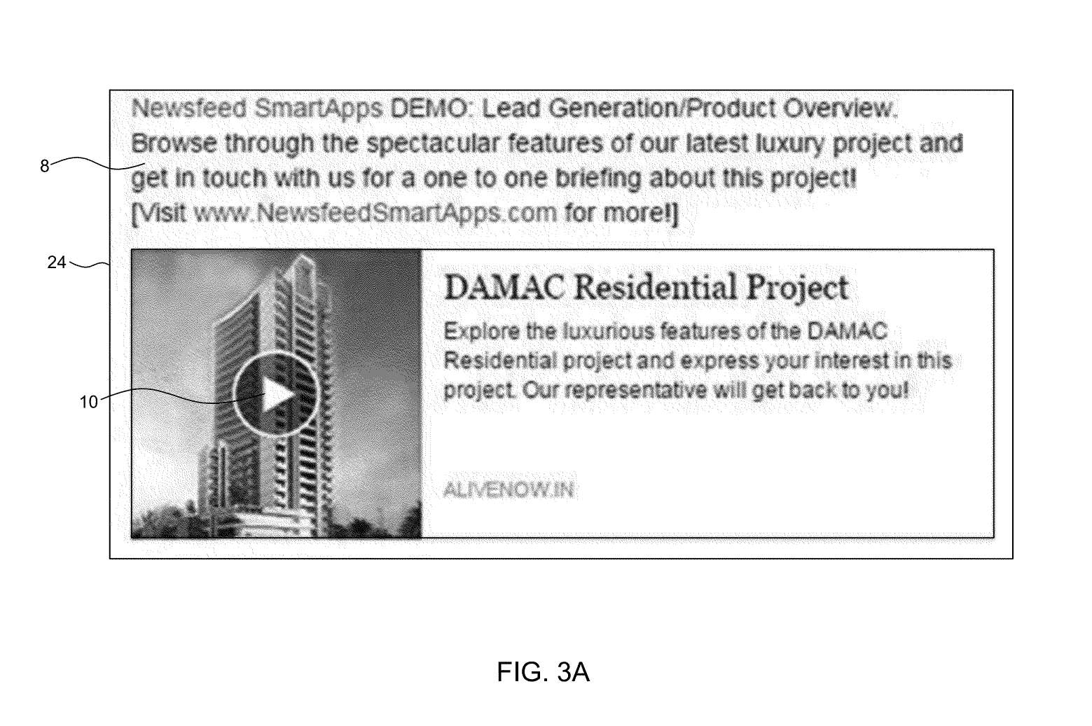

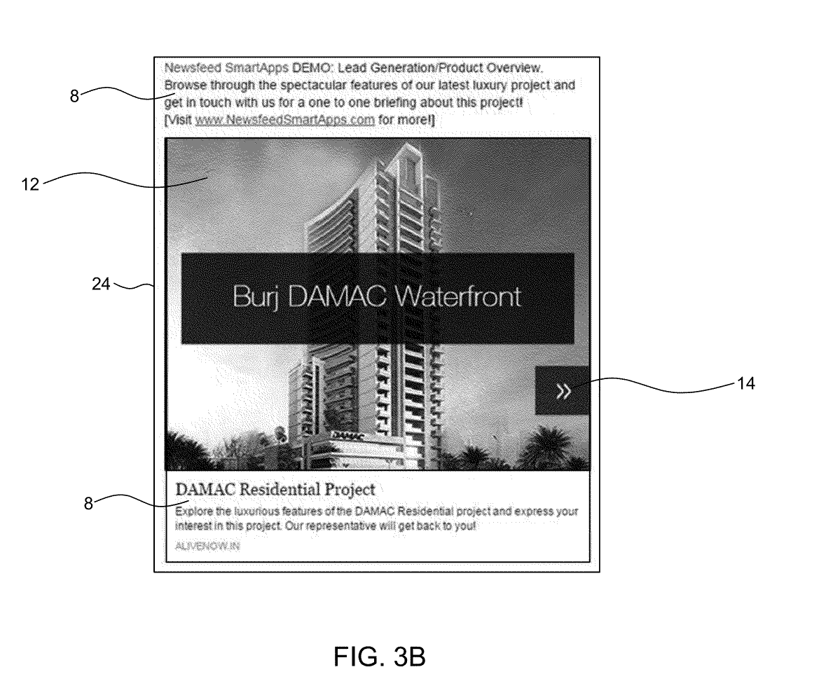

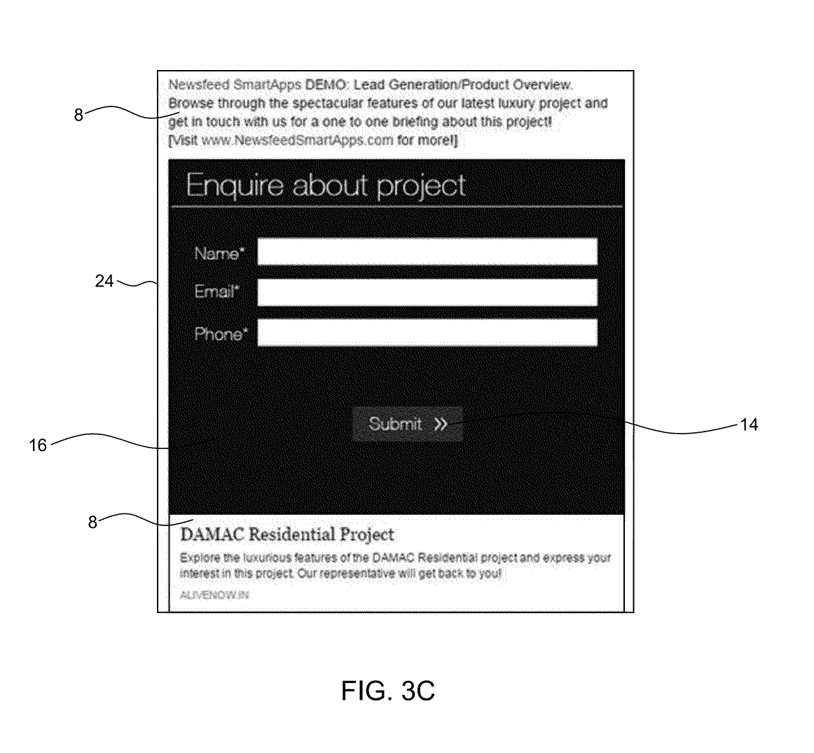

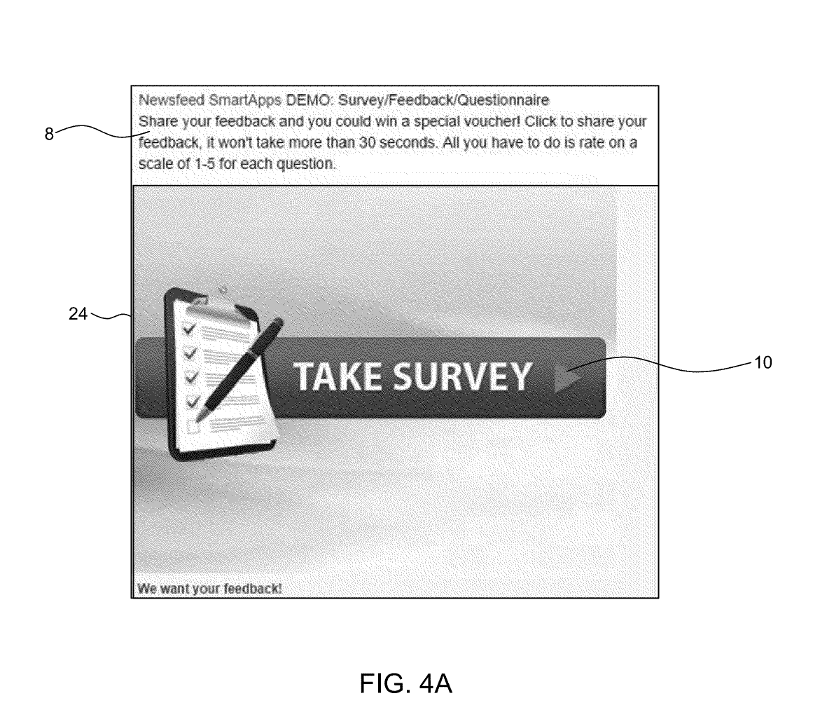

In FIG. 3a-c, the client computing device 20 is enabled to interact with the interface for displaying a presentation. By clicking the activation button 10, a set of display frames 12 are provided as seen in FIG. 3b, wherein the slides provide information regarding specific products or services and clicking these products or services provide more details. As represented in FIG. 3a textual content 8 is present within the newsfeed 24 to explain the function of that particular newsfeed 24. The products or services are displayed in the form of text, images, videos, infographs, etc. According to another embodiment, clicking on the specific object in the presentation closes down the web service and opens an external website or switches to display the external website to provide more details. According to another embodiments of the invention, the display frames of the presentation is programmed to automatically change after a set period of time, and it continuously moves from one display frame to another without any user input. In another embodiment, the presentation is automated for the first set of display frames, which is followed by a user input to continue with the automated presentation. According to an alternate embodiment, as represented in FIG. 3b, there are user inputs 14 present on the display frame 12 for controlled movement from one display frame 12 to the other as per the discretion of the user. The newsfeed 24 allows the user to choose one of the options on the newsfeed 24, after which a presentation type sliding screen appears to provide details regarding products.

According to another embodiment of the presentation newsfeed, by clicking on the activation button half the display frame is programmed to display product information which either moves automatically at set time periods or provides user inputs to move from one product details to the other. The other half of the display screen is the data input section where the user can enter details based on name, contact details, specific requirement, registration, more information on products, etc

According to one of the embodiments of the presentation newsfeed, as represented in FIG. 3c the client computing device 20 also interacts with the newsfeed 24 to collect data based on name, contact details, specific requirement, registration, more information on products, etc through a data input box 18 shown on the display frame 12, followed by which the user clicks on the user input 14 to submit the entered data, as shown in FIG. 3C.

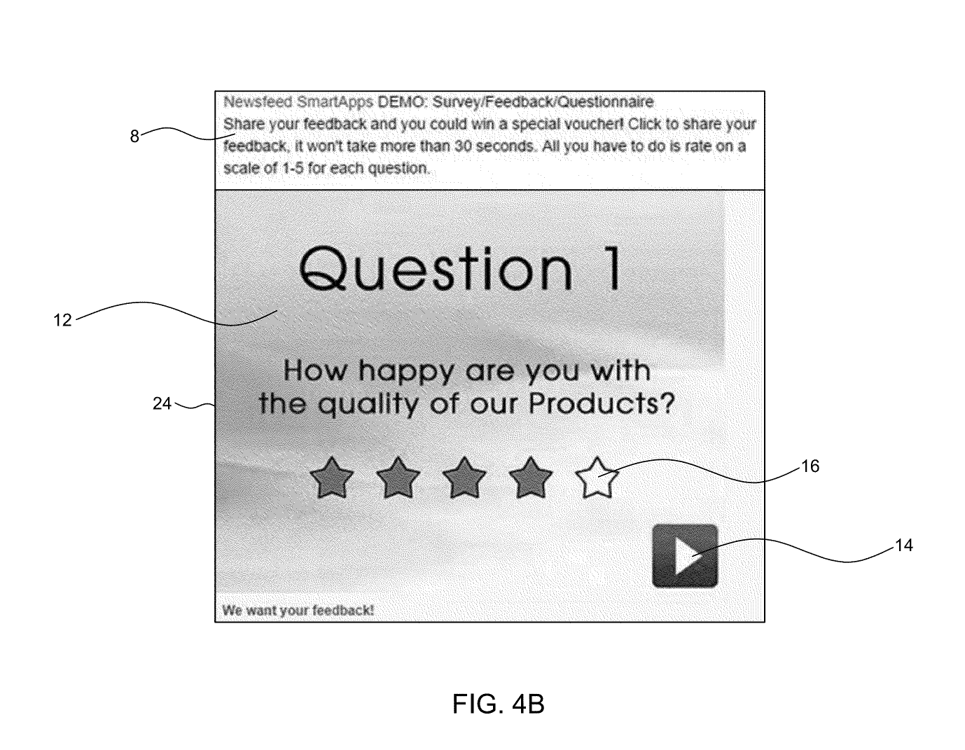

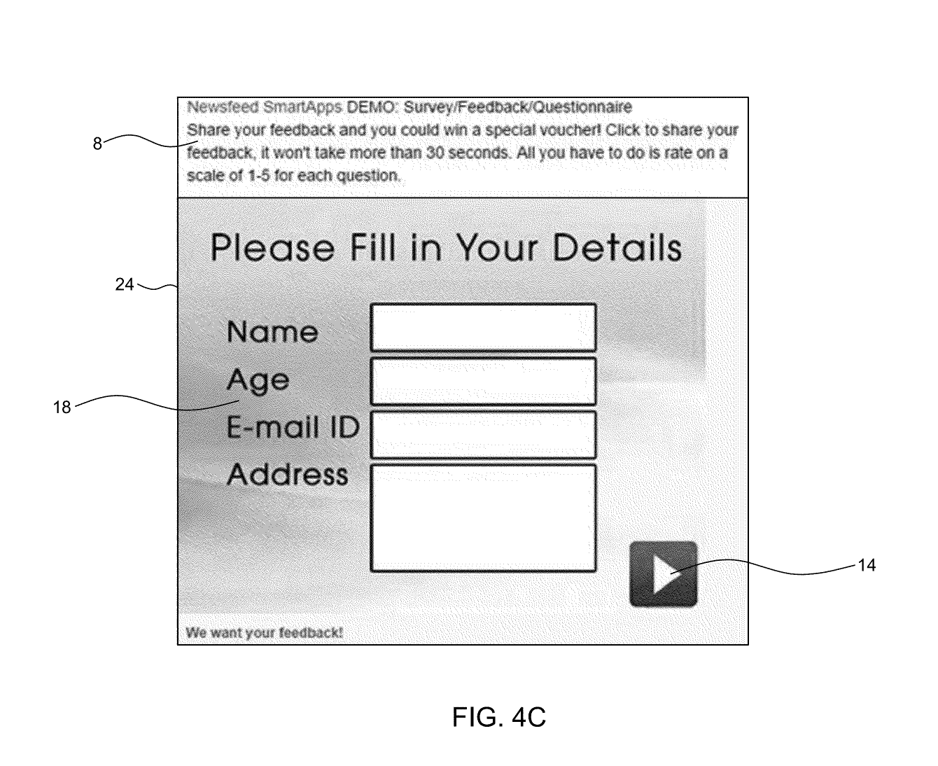

In FIG. 4a-c, the client computing device 20 is enabled to interact with the interface to participate in a survey. By clicking the activation button 10, the survey is presented on the display frame 12 with an array of data capturing question 16 which include 5 star ratings as displayed in FIG. 4B, or other forms of survey questions such as 5/5 or 10/10 ratings, yes/no ratings, qualitative ratings, quantitative ratings, percentage ratings, etc. Through these genres of newsfeed, data capture takes place within the display frame 12 as and when the user participates in the survey. In yet another embodiment, these surveys are provided in a multiple choice format, so the user may choose one of the options for the provided answers. In an alternate embodiment, the survey answers are provided in a drop down format wherein the user may choose the appropriate answer from the drop down menu.

In one of the embodiments of the survey type newsfeed, as represented in FIG. 4c the client computing device 20 also interacts with the newsfeed 24 to collect data based on name, contact details, specific requirement, registration, more information on products, etc through the data input box 18 shown on the display frame 12, followed by which the user clicks on the user input 14 submit button, as shown in FIG. 4c.

In a further embodiment, the survey is based on a feedback format wherein the computer program product provides data input boxes for the client computing device to interact with the interface to provide survey answers through typed text. In yet another preferred embodiment, the newsfeed provides a choice of language before beginning the survey, wherein the survey can be taken in a language other than English. The display frame provides separate user input for choosing the preferred language.

According to an alternate embodiment of the computer program product, the newsfeed is developed in a way to make specific calculations. One of the embodiments provides a calculation of bank reward points based on credit card limits provided by the bank. In similar way, other calculations may also be executed based on the type of interaction and type of input required. In another embodiment, the newsfeed can calculate interest rate based on principle amounts, bonus points based on reward cards, etc.

In a further embodiment, the processor enables the client computing device to interact with the interface by displaying an advertisement video which provides information and/or details regarding any products or services. On completion of the video, the newsfeed interacts with the client computing device wherein the user fills data input tabs to avail a free service, free gift, lucky draw contest, register for a service, etc. According to another embodiment, after watching the advertisement video, the newsfeed allows the user to pre-order the product advertised in the video directly on the newsfeed through the user input.

According to a further embodiment of the computer program product, the newsfeed is provided in the form of an image, wherein the characteristic of the image is altered with the help of a mouse clip or a keyboard command. In an exemplary embodiment of this newsfeed, on clicking the activation button the display frame shows an image in a black and white format, and moving the cursor to a specific point on the image and clicking the mouse or giving a keyboard command displays that specific area in a coloured format. Moving the cursor to another point on the image will then make the rest of the image black and white and show the selected section in a coloured format.

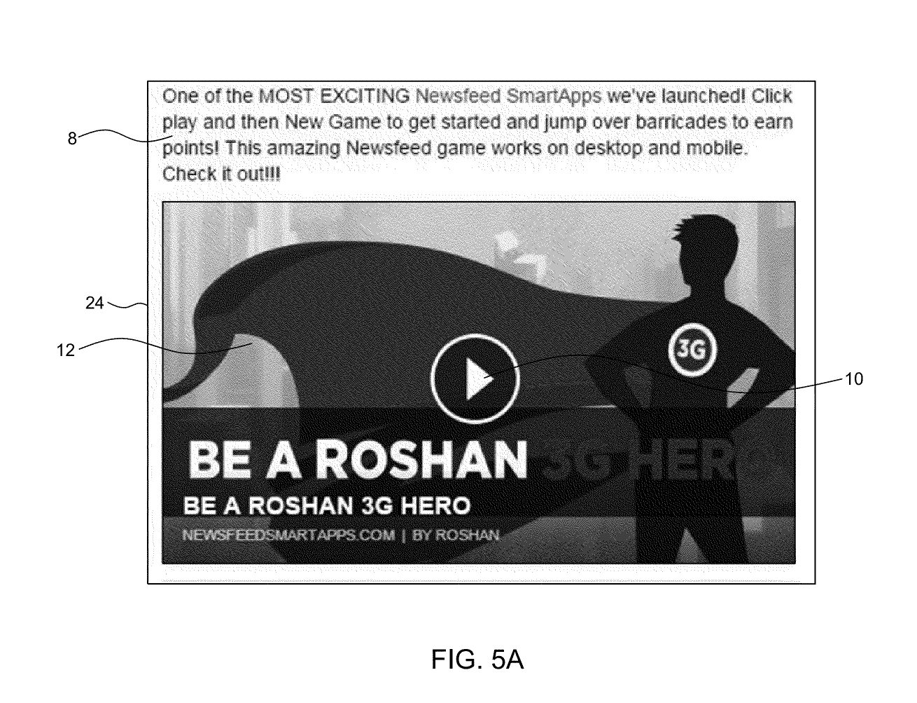

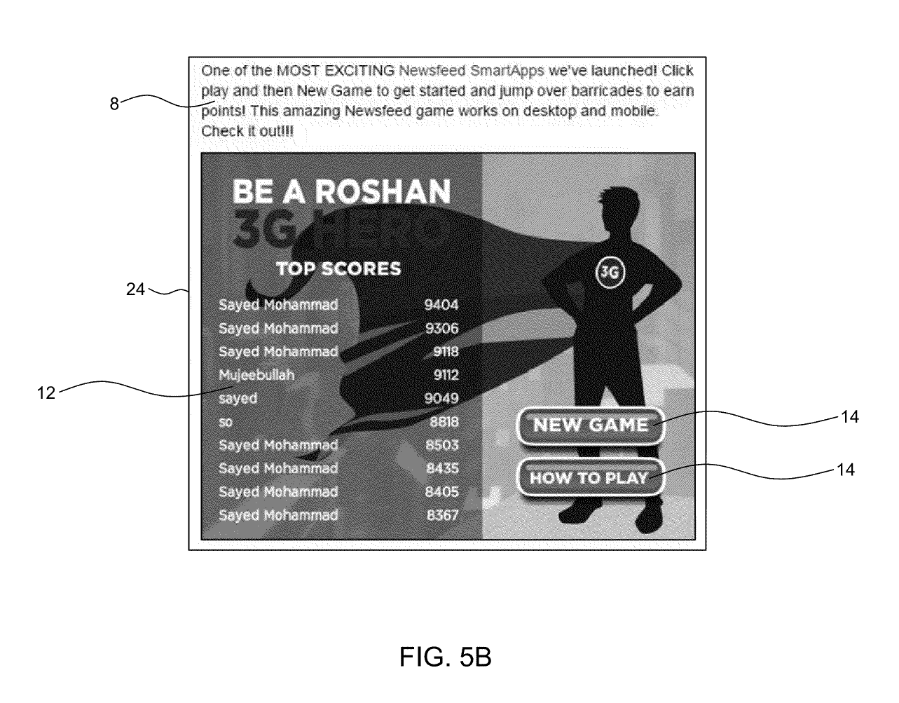

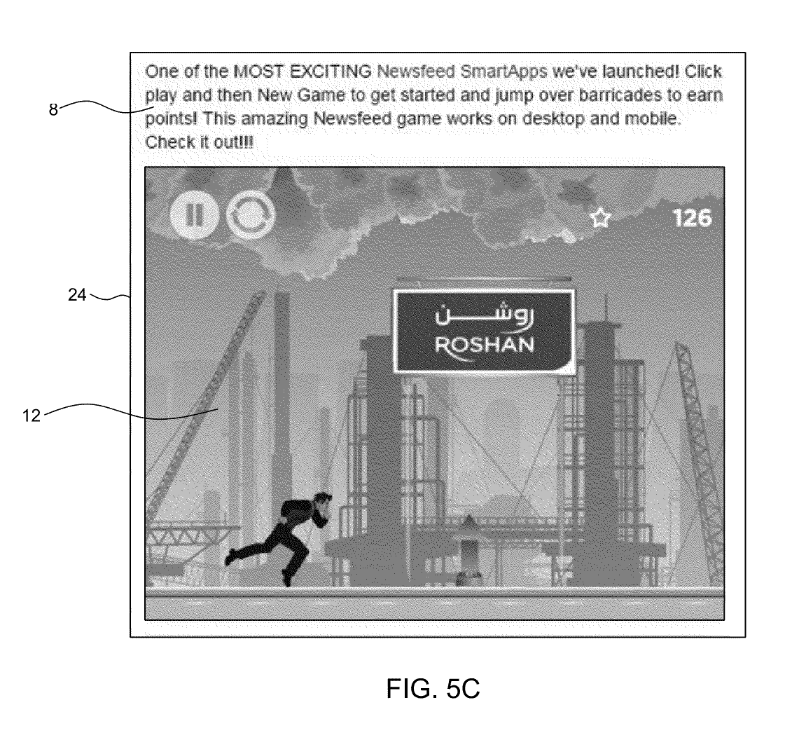

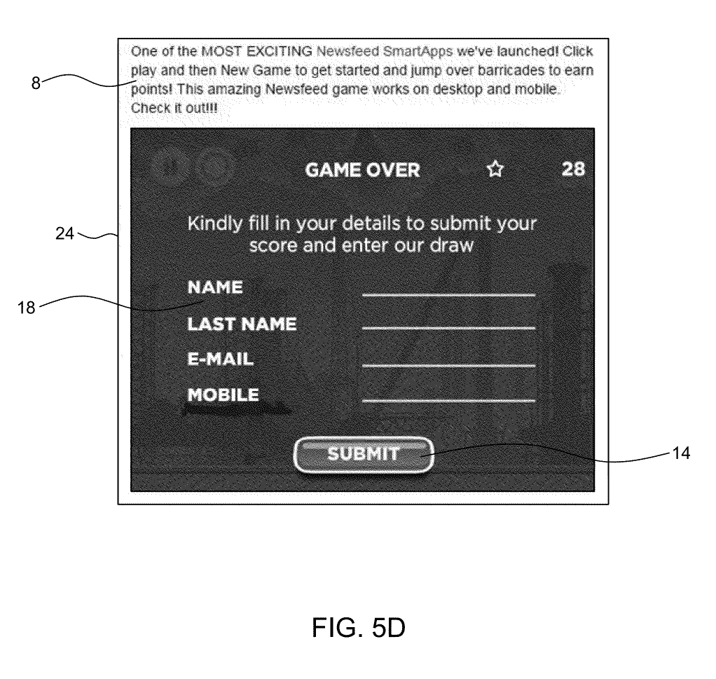

In FIG. 5a-d, the client computing device 20 is enabled to allow the user to play a game on the newsfeed 24. As illustrated in FIG. 5a, the display frame 12 consists of textual content 8 to explain to the user the function of the newsfeed. On clicking the activation button 10, it leads the user to play a game. As shown in FIG. 5b the display frame 10 provides user inputs 14 for the user to either begin a new game, or to know how to play the game. On clicking the user input 14 to play a new game the user utilizes the keyboard and/or the mouse to control the character in the game as represented in FIG. 5c. When the user loses the game, the client computing device 20 interacts with the newsfeed 24 to collect data based on name, contact details, specific requirement, registration, more information on products, etc through the data input box 18 shown on the display frame 12, followed by which the user clicks on the user input 14 submit button, as shown in FIG. 5d to avail any offers or discounts.

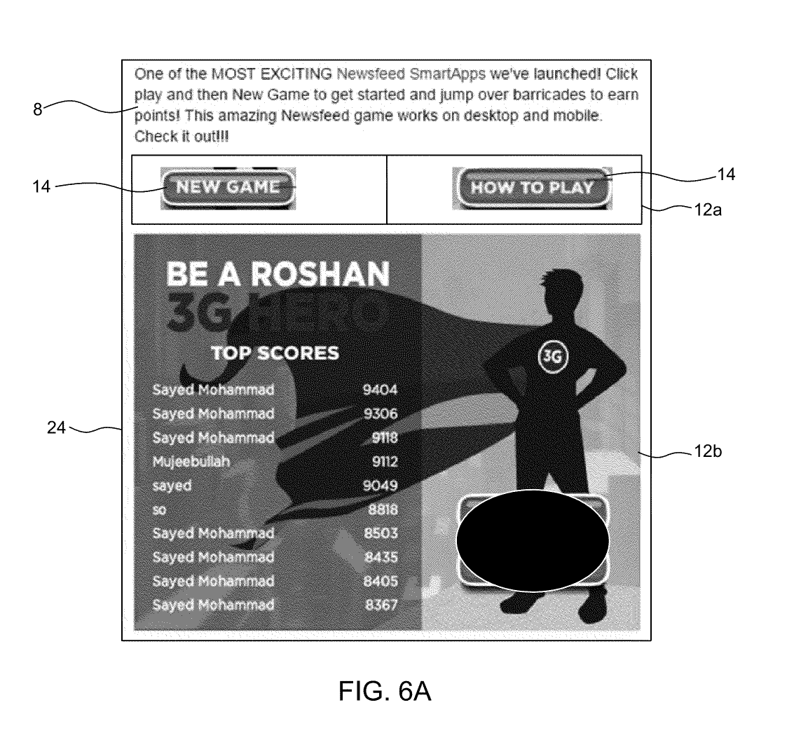

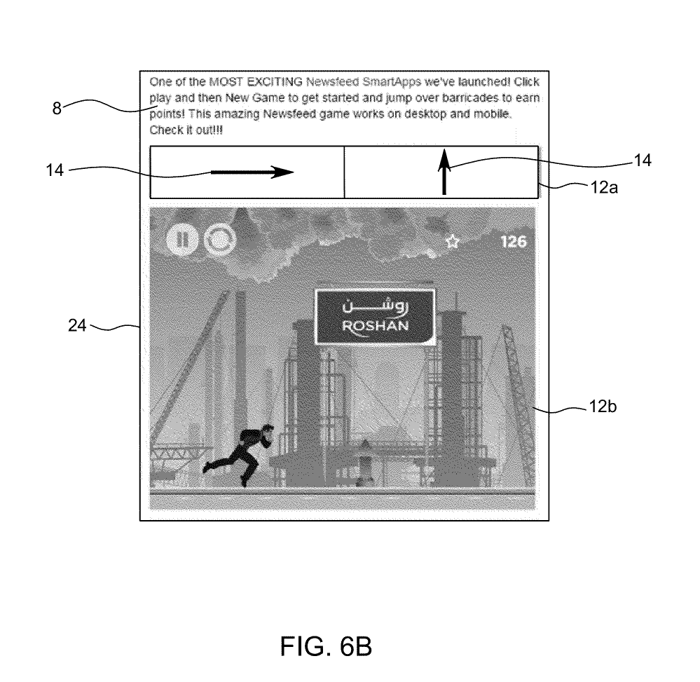

In FIG. 6a-b the computer program product is provided with newsfeed interface 24 having two part display frames 12a, 12b, such that one of the part executes the input action, and the other interface executes the output action. As shown in FIG. 5a clicking on the activation button 10 leads to the display frames as shown in FIG. 6b which displays user inputs 14, and clicking on the user input on the first display frame 12a activates the second display frame 12b. As shown in FIG. 6b, the user inputs 14 are used to control the action in the second display frame 12b.

In another embodiment of the invention, a game of unscramble is programmed such that providing the right answer gives the user a chance to avail free ticket for an event. According to this embodiment, the game is provided with a timer which begins when the activation button is clicked and runs till the user completes unscrambling of all the words. This embodiment does not allow the user to go to the next word, until the previous word is unscrambled.

According to another embodiment wherein any type of game can be programmed to entertain the users, and by playing the game, the user gets a chance to avail a gift, discount, register for a lucky draw etc. The client computing device also interacts with the newsfeed to collect data based on name, contact details, specific requirement, registration, more information on products, etc through the data input box 18 shown on the display frame 12, to avail the respective offers.

With respect to a further embodiment of the computer program product, the processor interacts with the client computing device wherein the display frame is provided to user in the form of a calendar. Each date contains specific information based on offers and other details. By clicking the activation button on the newsfeed interface the user can see a calendar, and by clicking on a specific date, which is present in the form of a user input, the user is provided with specific information. In one of the embodiments of this newsfeed, the calendar provides specific timings for the Islamic festival of Ramadan, in which during each day of the festival, the fast in broken at a specific time. These Sehar and Iftar timings are provided on this newsfeed, wherein clicking on each calendar date provides the fast breaking timing.

According to another embodiment of the calendar interface newsfeed, after clicking the activation button on the newsfeed, by clicked on each date it provides a special offer, and by clicking on this, the user can input the required details to avail the offer directly through the newsfeed.

As per another preferred embodiment of the interactive newsfeed, the client computing device is enabled to allow the user to participate in a voluntary contribution process. By clicking the activation button, the interface provides a display frame with few clickable tabs which can be chosen and transferred into a basket. These chosen items are then donated for a specific cause through the newsfeed. The client computing device also interacts with the newsfeed to collect data based on name, contact details, specific requirement, registration, etc through the data input boxes on the display frame, to avail a discount coupon or a gift.

In a further implementation of the invention, wherein the newsfeed allows the user to choose from one of several actions; on clicking the activation button the newsfeed interface begins with providing separate display frames to perform separate actions. By clicking on any of the user inputs, it leads the user to another display frame which allows the user to perform an interactive action. In one such exemplary newsfeed embodiment, the first tab leads to a display frame with a video advertisement for the user to view. The second tab is an interactive tab which has a type of game wherein the interface allows the user to pick and choose from the objects present on the newsfeed to create their own drink. The other tab provides a set of slides within the display frame that give information regarding recipes for specific drinks using the main drink that is being advertised. These recipe sheets are in the presentation format where the user can click on the user inputs to go from one recipe to the other. Also a user input for more details is provided. The user also has an option to go back and forth from one tab to the other if required.

In an alternate embodiment, after clicking the activation button, the display frame shows a number of tabs in the form of user inputs. Clicking on the user input leads the user to perform a specific activity; and further clicking of the user input alters the orientation of the tabs with respect to the primary display frame.

In an alternate embodiment, the interactive newsfeed allows the user to send out festive greetings from big brands to their loved ones through the newsfeed itself. By clicking the activation button, the user is directed to a display frame that contains data input boxes, to mention the details of the festive greetings, and the name and address details of who it needs to be delivered to. After entering the details the festive greetings, the message is delivered to their loved ones by the brand personnel itself.

According to a further embodiment, the processor of the interactive newsfeed 24 interacts with the client computing device 20 to provide any combination of the types of newsfeed actions mentioned above. The display frames consist of displaying presentation, playing a game, displaying a video, providing user input, providing survey questions, providing feedback options, providing informative slides, providing interactive display frames, provision for collecting data within the display, provision for collecting data from user, etc. A combination of any of these actions may give rise to a new embodiment of a newsfeed. The embodiments of the interactive newsfeed interface 24 is not limited to what has been mentioned above, there can be more actions performed through the newsfeed interface.

1. A computer program product adapted to be executed on a processor placed in a client-server environment and on execution adapted to enable the processor to perform the steps of:
requesting of a web service by a client computing device to a server computing device;
sending the web service and at least a news feed, by the server computing device to the client computing device;
displaying of the web service onto a display of the client computing device;
generating a news feed interface within an area of displayed web service;
displaying the news feed onto the interface;
enabling the client computing device to interact with the interface.

2. The computer program product according to claim 1, wherein the client computing device is enabled to receive an input through the interface and sending the input to the server computing device.

3. The computer program product according to claim 2, wherein the interface is adapted to display one or more subsequent display frames for receiving input through the client computing device.

4. The computer program product according to claim 3, wherein the subsequent display frame is displayed on either receiving requisite input on a current display frame or by clicking an activation button present on a current display frame.

5. The computer program product according to claim 1, wherein the client computing device is enabled to interact with the interface for displaying a presentation.

6. The computer program product according to claim 5, wherein the presentation is adapted to be interacted and controlled through an user input received by the client computing device.

7. The computer program product according to claim 1, wherein the client computing device is enabled to interact with the interface for playing a game.

8. The computer program product according to any the claim 1, wherein the processor is enabled to provide an activation module onto the interface to enable the client computing device to interact through the interface.

9. The computer program product according to the claim 1, wherein the web service is a social networking web platform.

10-13. (canceled)

14. A client-server system for displaying news feed over a web platform comprising:
a server computing device adapted to receive a request of a web service from a client computing device, and to send the web service along with at least a news feed to the client computing device; and
the client computing device comprising a display, the client computing device adapted to request a web service from a server computing device, to receive the web service along with at least a news feed from the server computing device, to display the web service onto the display, to generate a news feed interface within an area of displayed web service, to display the news feed onto the interface, to interact with the server computing device through the interface.

15. The client-server system according to claim 14, wherein the interface is adapted to display one or more subsequent display frames for receiving input through the client computing device.

16. The client-server system according to claim 15, wherein the subsequent display frame is displayed on either receiving requisite input on a current display frame or by clicking an activation button present on a current display frame.

17. The client-server system according to claim 14, wherein the client computing device is enabled to interact with the interface for displaying a presentation.

18. The client-server system according to claim 17, wherein the presentation is adapted to be interacted and controlled through an user input received by the client computing device.

19. The client-server system according to claim 17, wherein the client computing device is enabled to interact with the interface for playing a game.

20. A method for displaying news feed over a web platform comprising:
requesting of a web service by a client computing device to a server computing device;
sending the web service along with at least a news feed by the server computing device to the client computing device;
displaying of the web service onto a display of the client computing device;
generating a news feed interface within an area of displayed web service;
displaying the news feed onto the interface;
enabling the client computing device to interact with the interface.

21. The method according to claim 20 comprising:
receiving an input by the client computing device through the interface; and
sending the input to the server computing device.

22. The method according to claim 20 comprising:
displaying one or more subsequent display frames onto the interface; and
receiving the input onto the display frames.

23. The method according to claim 22, wherein the subsequent display frame is displayed on either receiving requisite input on a current display frame or by clicking an activation button present on a current display frame.

24. The client-server system according to claim 14, wherein providing an activation module onto the interface to enable the client computing device to interact through the interface.

25. The server computing device according to the claim 14, wherein the web service is a social networking web platform.
